(19) United States
(12) Patent Application Publication
(10) Pub. No.: US 2026/0159086 A1
(43) Pub. Date: Jun. 11, 2026

(54) METHOD AND SYSTEM FOR CONTROLLING VEHICLE AT MERGING SECTION

(71) Applicant: HL Klemove Corp., Incheon (KR)

(72) Inventor: Haejin HWANG, Incheon (KR)

(73) Assignee: HL Klemove Corp., Incheon (KR)

(21) Appl. No.: 19/060,969

(22) Filed: Feb. 24, 2025

(30) Foreign Application Priority Data
Dec. 11, 2024 (KR) 10-2024-0183759

(51) Int. Cl. B60W 30/165; B60W 30/14; B60W 30/18

(52) U.S. Cl. CPC B60W 30/165; B60W 30/146; B60W 30/18159; B60W 2420/403; B60W 2420/408; B60W 2554/802; B60W 2556/40; B60W 2556/50

(57) ABSTRACT

A method and a system for controlling a vehicle at a merging section are provided, and the method for controlling a vehicle at a merging section according to an embodiment of the present disclosure comprises: extracting a merging point where a driving lane of an ego vehicle and a merging lane meet; selecting vehicles of interest among surrounding vehicles located in the driving lane and the merging lane; rearranging the ego vehicle and the vehicles of interest based on remaining distances to the merging point; selecting a target space to enter among at least one space between the vehicles of interest and a rear space of a rearmost vehicle of interest; and controlling the ego vehicle to enter the target space.

### CROSS-REFERENCE TO RELATED APPLICATION

This application claims the benefit of and priority to Korean Patent Application No. 2024-0183759 filed on Dec. 11, 2024, the entire disclosures of which are incorporated herein by reference.

### TECHNICAL FIELD

The present disclosure relates to a method and system for controlling a vehicle at a merging section. More specifically, the present disclosure relates to a method and system for controlling the vehicle at the merging section to select a space to enter when the vehicle enters the merging section and control the vehicle to enter the space.

### BACKGROUND

In a vehicle, an Autonomous Driving System provides the function of driving to a given destination by recognizing the surrounding environment, assessing the driving situation, and controlling the vehicle without the driver's intervention.

Meanwhile, in the traffic environment, there are many sections where autonomous vehicles need to merge into other lanes, such as highway junctions (JC), interchanges (IC), and urban road intersections.

In such merging sections, it may be possible to respond by changing lanes, but in certain environments, such as where lanes merge immediately, it may be impossible to respond by changing lanes.

Furthermore, the functionality provided by conventional Driver Assistance Systems (DAS) performs target control only when a cut-in target or a forward target is selected. As a result, in merging sections, it is challenging to respond at the appropriate timing, which may increase the risk of collisions and cause sudden braking sensations to the driver.

Therefore, there is a need for a method and system for controlling the vehicle at the merging section to select a space for the vehicle to enter and enable the vehicle to smoothly enter the selected space.

### SUMMARY

The present disclosure is to solve the above-mentioned problems of the prior art, and the object of the present disclosure is to provide a method and system for controlling the vehicle at the merging section, which selects a space to enter among the spaces between the vehicles in the driving lane of the ego vehicle and the merging lane, even at merging sections where merging by changing lanes are not possible, and enables the vehicle to enter the selected space.

Further, the object of the present disclosure is to provide a method and system for controlling the vehicle at the merging section that can enhance the performance of autonomous driving by reducing the risk of collision in merging sections and facilitating timely merging by segmenting the control strategies to enter the target space.

However, the technical problem to be achieved by the embodiments of the present disclosure is not limited to the technical problems described above, and other technical problems may exist.

As a technical means for achieving the above technical problem, a method for controlling a vehicle at a merging section according to an embodiment of the present disclosure comprises: extracting a merging point where a driving lane of an ego vehicle and a merging lane meet; selecting vehicles of interest among surrounding vehicles located in the driving lane and the merging lane; rearranging the ego vehicle and the vehicles of interest based on remaining distances to the merging point; selecting a target space to enter among at least one space between the group of the vehicles of interest and a rear space of a rearmost vehicle of interest; and controlling the ego vehicle to enter the target space.

Further, the rearranging the ego vehicle and the vehicles of interest based on the remaining distances to the merging point may comprise arranging the ego vehicle and the vehicles of interest in order from a vehicle with a shortest remaining distance to the merging point to a vehicle with a longest remaining distance, and the selecting of the target space may comprise selecting the target space based on a reward function in the rearranged state.

Further, in the reward function, a reward value may increase as a size of the target space becomes larger.

Further, in the reward function, a reward value may increase as a speed loss required for the ego vehicle to enter the target space decreases.

Further, in the reward function, a reward value may increase as a travel distance required for the ego vehicle to enter the target space decreases.

Further, the controlling of the ego vehicle may comprise selecting a vehicle of interest located in front of the target space as a target vehicle and performing longitudinal control to follow the target vehicle.

Further, the controlling of the ego vehicle may comprise, when the target vehicle is located behind the ego vehicle, performing deceleration control to move behind the target vehicle.

Further, the method may further comprise: if the target space cannot be selected, stopping or decelerating the ego vehicle before reaching the merging point and re-searching for the target space.

Further, the extracting of the merging point may comprise detecting a location of the ego vehicle based on a GNSS (Global Navigation Satellite System); and extracting road shape information of the driving lane and the merging lane based on the location of the ego vehicle and information from a high-definition map.

Further, the extracting of the merging point may comprise extracting the merging point based on the extracted road shape information.

A system for controlling a vehicle at a merging section according to the embodiments of the present disclosure comprises: a first sensor configured to detect surrounding vehicles located in a driving lane of an ego vehicle and a merging lane; a second sensor configured to detect a location of the ego vehicle and surrounding road information; and a controller including at least one processor configured to control the ego vehicle at the merging section based on detection results of the first sensor and the second sensor, wherein the controller is configured to extract a merging point where the driving lane and the merging lane meet, select vehicles of interest among the surrounding vehicles, rearrange the ego vehicle and the vehicles of interest based on remaining distances to the merging point, select a target space to enter among at least one space between the vehicles of interest and a rear space of a rearmost vehicle of interest and control the ego vehicle to enter the target space.

Further, the system may further comprise: a driving apparatus configured to control a longitudinal driving of the ego vehicle; a braking apparatus configured to control a braking of the ego vehicle; and a steering apparatus configured to control a lateral driving of the ego vehicle, and, the controller may be configured to control at least one of the driving apparatus, the braking apparatus and the steering apparatus so that the ego vehicle enters the target space.

Further, the first sensor may comprise at least one of a front camera, a front radar, and a corner radar, and the second sensor may comprise a GNSS (Global Navigation Satellite System) and a high-definition map.

Further, the controller may be configured to rearrange the ego vehicle and the vehicles of interest in order from a vehicle with a shortest remaining distance to the merging point to a vehicle with a longest remaining distance, and select the target space based on a reward function in the rearranged state.

Further, in the reward function, a reward value may increase as a size of the target space becomes larger, as a speed loss required for the ego vehicle to enter the target space decreases, and as a travel distance required for the ego vehicle to enter the target space decreases.

Further, the controller may be configured to select a vehicle of interest located in front of the target space as a target vehicle and perform control of the ego vehicle to follow the target vehicle.

Further, when the target vehicle is located behind the ego vehicle, the controller may be configured to perform deceleration control of the ego vehicle by controlling the braking apparatus to move behind the target vehicle.

Further, if the target space cannot be selected, the controller may be configured to stop or decelerate the ego vehicle before reaching the merging point and re-search for the target space.

Further, the controller may be configured to extract road shape information of the driving lane and the merging lane based on the location of the ego vehicle and information from the high-definition map, and extract the merging point based on the road shape information.

In a non-transitory computer-readable recording medium that records a program for executing a method for controlling a vehicle at a merging section on a computer according to an embodiment of the present disclosure, the method comprises: extracting a merging point where a driving lane of an ego vehicle and a merging lane meet; selecting vehicles of interest among surrounding vehicles located in the driving lane and the merging lane; rearranging the ego vehicle and the vehicles of interest based on remaining distances to the merging point; selecting a target space to enter among at least one space between the vehicles of interest and a rear space of a rearmost vehicle of interest; and controlling the ego vehicle to enter the target space.

The above-described means for solving the problem is only exemplary and should not be construed as limiting the present disclosure. In addition to the exemplary embodiments described above, additional embodiments may exist in the drawings and the following detailed description.

According to the above-described problem-solving means of the present disclosure, it is possible to provide a method and system for controlling a vehicle at a merging section that can reduce the risk of collision in merging sections and enables smooth merging without sudden braking by selecting a space to enter among the spaces between the vehicles in the merging section and controlling the vehicle to enter the selected space.

However, the effects obtainable from the present disclosure are not limited to the effects described above, and other effects may exist.

### BRIEF DESCRIPTION OF THE DRAWINGS

FIG. 1 is a control flowchart showing a method for controlling a vehicle at a merging section according to an embodiment of the present disclosure.

FIGS. 2A to 2D are diagrams showing examples of the merging section in the method for controlling the vehicle at the merging section according to the embodiment of the present disclosure.

FIG. 3 is a diagram illustrating a method of rearranging the ego vehicle and the vehicles of interest based on the remaining distances to the merging point in the method for controlling the vehicle at the merging section according to the embodiment of the present disclosure.

FIG. 4 is a diagram illustrating a method of selecting a target space and controlling the ego vehicle to enter the selected target space in the method for controlling the vehicle at the merging section according to the embodiment of the present disclosure.

FIG. 5 is a control configuration diagram schematically showing the configuration of a system for controlling the vehicle at the merging section according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for controlling a vehicle at a merging section, which selects a space to enter among the spaces between the surrounding vehicles in the driving lane of the ego vehicle and the merging lane and controls the ego vehicle to enter the selected space.

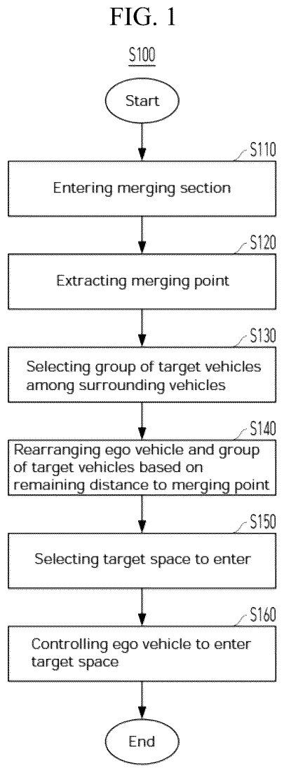

FIG. 1 is a control flowchart showing a method for controlling a vehicle at a merging section according to an embodiment of the present disclosure.

Referring to FIG. 1 of the present disclosure, the method for controlling the vehicle at the merging section S100 according to an embodiment of the present disclosure may comprise a step of entering the merging section S110 and a step of extracting the merging point where the driving lane of the ego vehicle and the merging lane meet S120.

Here, the merging lane may refer to a lane that merges with the driving lane of the ego vehicle at a forward location.

The step of extracting the merging point S120 may comprise a step of detecting the location of the ego vehicle based on a GNSS (Global Navigation Satellite System) and extracting road shape information based on the detected location of the ego vehicle and information from a high-definition map (HD Map).

Furthermore, the step of extracting the merging point S120 may extract the merging point based on the road shape information extracted as described above.

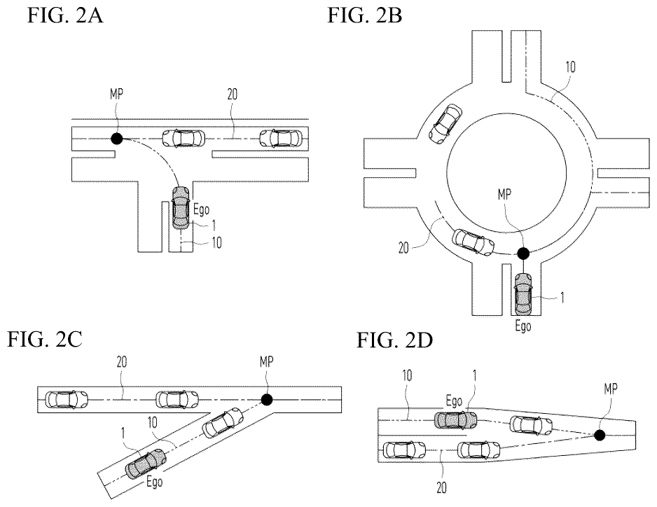

Specifically, information about the centerline of the lane may be extracted from the high-definition map, and the point where the centerline of the driving lane of the ego vehicle meets the centerline of the merging lane may be extracted as the merging point. The merging section and the merging point will be explained in more detail in the description of FIGS. 2A to 2D.

Subsequently, a step of selecting vehicles of interest among surrounding vehicles located in the driving lane and the merging lane S130 may be performed. For example, surrounding vehicles that are driving ahead of the ego vehicle in the driving lane of the ego vehicle, and vehicles driving in the merging lane may be selected as the vehicles of interest (a group of vehicles being interested).

Subsequently, a step of rearranging the ego vehicle and the vehicles of interest based on the remaining distances to the merging point S140 may be performed.

The step of rearranging S140 may rearrange the ego vehicle and the vehicles of interest based on the remaining distances to the merging point, specifically from the vehicle with the shortest remaining distance to the merging point to the vehicle with the longest remaining distance.

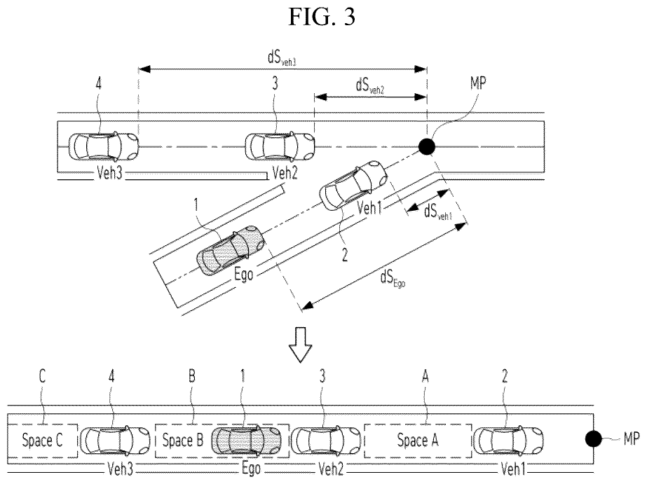

The method of rearranging the ego vehicle and the vehicles of interest will be described in more detail in the explanation of FIG. 3.

Subsequently, a step of selecting a target space to enter among at least one space between the vehicles of interest and the rear space of the rearmost vehicle of interest in the rearranged state S150 may be performed.

For example, the target space may be selected based on a reward function in the rearranged state of the ego vehicle and the vehicles of interest.

The reward function may be set so that the reward value increases as the size of the target space becomes larger. Additionally, the reward function may be set so that the reward value increases as the speed loss required for the ego vehicle to enter the target space decreases. Furthermore, the reward function may be set so that the reward value increases as the travel distance required for the ego vehicle to enter the target space decreases. However, these are only examples, and the criteria of setting the reward function may vary.

Here, the space ahead of the nearest front vehicle to the ego vehicle in the driving lane of the ego vehicle cannot be selected. This is because the ego vehicle cannot enter the merging point while overtaking the front vehicle in the driving lane.

Meanwhile, if the target space to enter cannot be selected, a step of stopping or decelerating the ego vehicle before reaching the merging point and re-searching for the target space may be performed.

Subsequently, after the target space is selected, a step of controlling the ego vehicle to enter the target space S160 may be performed.

For example, a vehicle located in front of the target space may be selected as the target vehicle, and longitudinal control may be performed to follow the selected target vehicle.

Here, if the target vehicle is located behind the ego vehicle, deceleration control to move behind the target vehicle may be performed first.

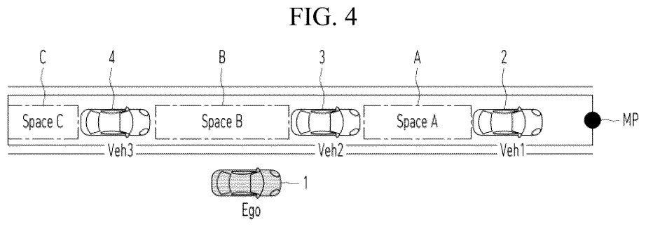

The method of controlling the ego vehicle to enter the target space will be described in more detail in the explanation of FIG. 4.

According to the method for controlling the vehicle at the merging section according to an embodiment of the present disclosure, it is possible to reduce the risk of accidents in the merging section and facilitate smooth entry at the merging point by selecting a space to enter among spaces between vehicles and by controlling the ego vehicle to enter the selected space.

FIGS. 2A to 2D are diagrams showing examples of the merging section in the method for controlling the vehicle at the merging section according to the embodiment of the present disclosure.

Referring to FIGS. 2A to 2D, merging scenarios at merging sections may comprise a case where merging occurs at a T-junction (FIG. 2A), a case where merging occurs at a circular intersection (FIG. 2B), a case where merging occurs at a lane entrance (FIG. 2C), or a case where merging occurs due to a lane closure (FIG. 2D). However, these are only examples, and the method for controlling the vehicle at the merging section according to embodiments of the present disclosure may also be applied to other scenarios including merging sections.

As illustrated in FIGS. 2A to 2D, in each merging section, the merging point (MP), where the driving lane 10 of the ego vehicle 1 meets the merging lane 20, may be extracted.

For example, based on information about centerlines of the road extracted from an HD map, the point where the centerline of the driving lane meets the centerline of the merging lane may be determined as the merging point.

Meanwhile, in the merging situations shown in FIGS. 2A to 2D including merging sections with insufficient space for lane changes, conventional merging methods involving lane changes cannot be applied. The method for controlling the vehicle at the merging section according to the embodiment of the present disclosure can be applicable to various merging situations by selecting a space to enter among spaces between vehicles and controlling the vehicle to enter the selected space.

In the following explanation of FIG. 3 and FIG. 4, the step of selecting the vehicles of interest, the step of rearranging the ego vehicle and the vehicles of interest, the step of selecting the target space, and the step of controlling the ego vehicle to enter the target space in accordance with an embodiment of the present disclosure will be described in more detail using the case where merging occurs at a lane entrance (FIG. 2C) as an example.

FIG. 3 is a diagram illustrating a method of rearranging the ego vehicle and the vehicles of interest based on the remaining distances to the merging point in the method for controlling the vehicle at the merging section according to the embodiment of the present disclosure.

Referring to FIG. 3, the ego vehicle 1, the surrounding vehicle 2 located in front of the ego vehicle 1 in the driving lane, and the surrounding vehicles 3, 4 driving in the merging lane may be selected as the vehicles of interest (hereinafter referred to as ‘first vehicle of interest 2,’ ‘second vehicle of interest 3,’ and ‘third vehicle of interest 4’ respectively). Meanwhile, for example, surrounding vehicles located behind the ego vehicle 1 in the driving lane may not be selected as the vehicle of interest.

After the vehicles of interest are selected, the ego vehicle 1 and the vehicles of interest 2, 3, 4 may be rearranged based on their remaining distances to the merging point MP.

For instance, the ego vehicle 1 and the vehicles of interest 2, 3, 4 may be arranged in the order from the vehicles with shorter remaining distances to the merging point MP to the vehicles with longer distances. In FIG. 3, the remaining distances from the vehicles of interest 2, 3, 4 to the merging point MP may be expressed as the distance between the first vehicle of interest 2 and the merging point MP (dSᵥₑₕ₁), the distance between the second vehicle of interest 3 and the merging point MP (dSᵥₑₕ₂), the distance between the ego vehicle 1 and the merging point MP (dS_{ego}), and the distance between the third vehicle of interest 4 and the merging point (dSᵥₑₕ₃). In this case, the relationship is as follows dSᵥₑₕ₁<dSᵥₑₕ₂<dS_{ego}<dSᵥₑₕ₃. Accordingly, as shown in the lower drawing of FIG. 3, it would be rearranged in order of the first vehicle of interest 2, the second vehicle of interest 3, the ego vehicle 1, and the third vehicle of interest 4.

Meanwhile, in the rearranged state, there exist spaces A and B located between the vehicles of interest 2, 3, 4 and a rear space C located behind the rearmost vehicle of interest 4. Among these spaces A, B, C, a target space may be selected. The method of selecting the target space will be explained in more detail in the description of FIG. 4 below.

FIG. 4 is a diagram illustrating a method of selecting a target space and controlling the ego vehicle to enter the selected target space in the method for controlling the vehicle at the merging section according to the embodiment of the present disclosure.

Referring to FIG. 4, a target space may be selected among the spaces A, B between the target vehicles 2, 3, 4 and the rear space C behind the rearmost vehicle of interest 4. For example, the target space may be selected based on a reward function.

The reward function may be set so that the reward value increases as the size of the target space becomes larger.

For example, referring to FIG. 4, the space B has the largest size and thus the space B may have the highest reward value. The space A is smaller than the space B and the space C is the smallest, and thus, the space C may have the lowest reward value.

Additionally, the reward function may be set so that the reward value increases as the speed loss required for the ego vehicle 1 to enter the target space decreases.

Referring to FIG. 4, the space A is ahead of the ego vehicle 1, and the space B is at the same longitudinal distance as the ego vehicle 1. Thus, the ego vehicle 1 does not need to decelerate when entering the spaces A or B. However, the space C is behind the ego vehicle 1, so entering the space C would require deceleration and lead to speed loss. Therefore, in this case, the space C may have a lower reward value.

Furthermore, the reward function may also be set so that the reward value increases as the travel distance required for the ego vehicle 1 to enter the target space decreases.

Referring to FIG. 4, when comparing the distances between the ego vehicle 1 and the spaces A, B, and C, the distance between the ego vehicle 1 and the space B is the shortest. Therefore, entering the space B requires the shortest travel distance. Consequently, a higher reward value may be set for the space B.

Next, referring to FIG. 4, the method of controlling the ego vehicle to enter the selected target space after the target space is selected will be described.

Once the target space is selected, a vehicle located in front of the target space in the rearranged state may be selected as a target vehicle, and longitudinal control to follow the target vehicle may be performed.

For example, if the space A is selected as the target space, the vehicle in front of the space A is the first target vehicle 2, which is the closest vehicle in the driving lane of the ego vehicle 1. If the first vehicle of interest 2 is selected as the target vehicle, longitudinal control of the ego vehicle 1 may be performed to follow the first vehicle of interest 2.

In this case, to enter the space A, the ego vehicle 1 needs to be ahead of the second vehicle of interest 3, so the target inter-vehicle distance with respect to the front vehicle may be shorter compared to the conventional control for following the front vehicle.

On the other hand, if the space B is selected as the target space, the vehicle in front of the space B is the second vehicle of interest 3, which is a vehicle positioned in the merging lane. In this case, the second vehicle of interest 3 may be pre-selected as the target vehicle, and longitudinal control of the ego vehicle 1 may be performed to follow the second vehicle of interest 3.

Furthermore, if the space C is selected as the target space, the vehicle located in front of the space C is the third vehicle of interest 4 located at the rearmost, which is a vehicle positioned in the merging lane. On the other hand, in the rearranged state based on the remaining distances to the merging point MP, the third vehicle of interest 4 is located behind the ego vehicle 1. Therefore, a deceleration command (e.g., −1 m/s²) may be generated to move the ego vehicle 1 behind the third vehicle of interest 4. At this point, through the action of deceleration in response to the deceleration command, a yielding signal may be sent to the third vehicle of interest 4.

However, this is only an example, and the acceleration or deceleration commands may vary depending on factors such as the relative speed, relative distance, or the remaining distances to the merging point MP of the ego vehicle 1 and the third vehicle of interest 4.

Subsequently, if the ego vehicle 1 moves behind the third vehicle of interest 4, the third vehicle of interest 4 may be selected as the target vehicle, and longitudinal control of the ego vehicle 1 may be performed to follow the third vehicle of interest 4.

If a target space for the ego vehicle 1 to enter cannot be selected, the ego vehicle 1 may stop at the merging point or generate a deceleration command, and then re-search for the target space to enter.

According to the method for controlling the vehicle at the merging section according to the embodiment of present disclosure, it is possible to reduce the risk of accidents at the merging section and improve the performance of autonomous driving by selecting the space to enter based on the reward function and controlling the vehicle to enter the selected space.

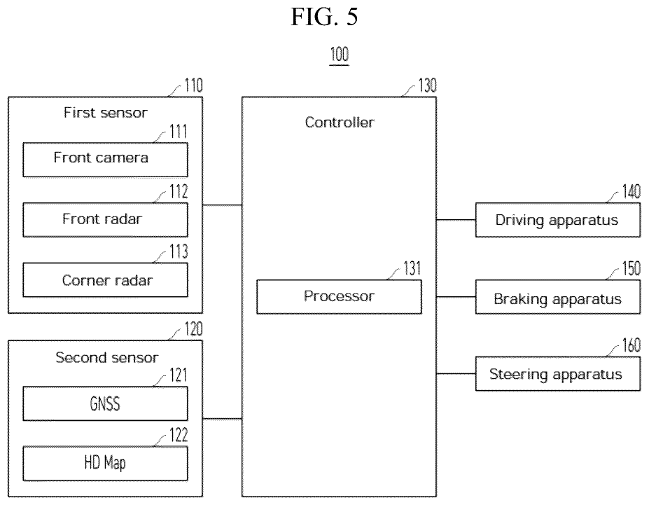

FIG. 5 is a control configuration diagram schematically showing the configuration of a system for controlling the vehicle at the merging section according to embodiments of the present disclosure.

Referring to FIG. 5, the system for controlling the vehicle at the merging section 100 according to embodiments of the present disclosure may comprise a first sensor 110 configured to detect surrounding vehicles in the driving lane of the ego vehicle and the merging lane, a second sensor 120 configured to detect the location of the ego vehicle and surrounding road information, and a controller 130 including at least one processor 131 to control the ego vehicle at the merging section based on the detection results from the first sensor 110 and the second sensor 120.

The controller 130 may extract the merging point where the driving lane and the merging lane meet, select vehicles of interest among the surrounding vehicles, rearrange the ego vehicle and the vehicles of interest based on the remaining distances to the merging point, select a target space among at least one space between the vehicles of interest and the rear space of the rearmost vehicle of interest, and control the ego vehicle to enter the selected target space.

The first sensor 110 may comprise at least one of a front camera 111, a front radar 112, or a corner radar 113. However, it is not limited to these, and other types of sensors, such as ultrasonic sensors for detecting the vehicle's surroundings, may also be included.

The second sensor 120 may comprise GNSS 121 and high-definition map (HD Map) 122. However, it is not limited to these, and other sensors or maps that can detect the ego vehicle's location and surrounding road information may also be included.

Additionally, the system for controlling the vehicle at the merging section 100 according to embodiments of the present disclosure may further comprise a driving apparatus 140 configured to control the longitudinal driving of the ego vehicle, a braking apparatus 150 configured to control the braking of the ego vehicle, and a steering apparatus 160 configured to control the lateral driving of the ego vehicle.

When a target space is selected among at least one space between the vehicles of interest or the rear space of the rearmost vehicle of interest, the controller 130 may control at least one of the driving apparatus 140, the braking apparatus 150, and the steering apparatus 160 for the ego vehicle to enter the selected target space.

Meanwhile, since the method for controlling the vehicle at the merging section according to the embodiment of the present disclosure performed by the controller 130 has been described in detail previously, detailed description will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure, it is possible to provide the method and system for controlling the vehicle at the merging section that allows the ego vehicle to enter the merging point even in situations where there is insufficient space for a lane change, by selecting the space to enter based on the relationship between the vehicles in the driving lane and the merging lane and by controlling the vehicle to enter the selected space.

Furthermore, according to the method and system for controlling the vehicle at the merging section according to the embodiments of the present disclosure, it is possible to significantly improve the performance of autonomous vehicles by breaking down the control strategy into finer steps for entering the target space in the merging lane, thereby enabling the vehicle to enter the merging section without sudden braking.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2, 3, 4: Vehicle of interest
A, B, C: Space
10: Driving lane
20: Merging lane
MP: Merging point
100: System for controlling a vehicle at a merging section
110: First sensor
111: Front camera
112: Front radar
113: Corner radar
120: Second sensor
121: GNSS
122: HD Map
130: Controller
131: Processor
140: Driving apparatus
150: Braking apparatus
160: Steering apparatus

What is claimed is:

1. A method for controlling a vehicle at a merging section, comprising:
extracting a merging point where a driving lane of an ego vehicle and a merging lane meet;
selecting vehicles of interest among surrounding vehicles located in the driving lane and the merging lane;
rearranging the ego vehicle and the vehicles of interest based on remaining distances to the merging point;
selecting a target space to enter among at least one space between the vehicles of interest and a rear space of a rearmost vehicle of interest; and
controlling the ego vehicle to enter the target space.

2. The method of claim 1, wherein the rearranging of the ego vehicle and the vehicles of interest based on the remaining distances to the merging point comprises arranging the ego vehicle and the vehicles of interest in order from a vehicle with a shortest remaining distance to the merging point to a vehicle with a longest remaining distance, and
the selecting of the target space comprises selecting the target space based on a reward function in the rearranged state.

3. The method of claim 2, wherein in the reward function, a reward value increases as a size of the target space becomes larger.

4. The method of claim 2, wherein in the reward function, a reward value increases as a speed loss required for the ego vehicle to enter the target space decreases.

5. The method of claim 2, wherein in the reward function, a reward value increases as a travel distance required for the ego vehicle to enter the target space decreases.

6. The method of claim 1, wherein the controlling of the ego vehicle comprises selecting a vehicle of interest located in front of the target space as a target vehicle and performing longitudinal control to follow the target vehicle.

7. The method of claim 6, wherein the controlling of the ego vehicle comprises, when the target vehicle is located behind the ego vehicle, performing deceleration control to move behind the target vehicle.

8. The method of claim 1, further comprising:
if the target space cannot be selected, stopping or decelerating the ego vehicle before reaching the merging point and re-searching for the target space.

9. The method of claim 1, wherein the extracting of the merging point comprises detecting a location of the ego vehicle based on a GNSS (Global Navigation Satellite System);
and extracting road shape information of the driving lane and the merging lane based on the location of the ego vehicle and information from a high-definition map.

10. The method of claim 9, wherein the extracting of the merging point comprises extracting the merging point based on the extracted road shape information.

11. A system for controlling a vehicle at a merging section, comprising:
a first sensor configured to detect surrounding vehicles located in a driving lane of an ego vehicle and a merging lane;
a second sensor configured to detect a location of the ego vehicle and surrounding road information; and
a controller including at least one processor configured to control the ego vehicle at the merging section based on detection results of the first sensor and the second sensor,
wherein the controller is configured to extract a merging point where the driving lane and the merging lane meet, select vehicles of interest among the surrounding vehicles, rearrange the ego vehicle and the vehicles of interest based on remaining distances to the merging point, select a target space to enter among at least one space between the vehicles of interest and a rear space of a rearmost vehicle of interest and control the ego vehicle to enter the target space.

12. The system of claim 11, further comprising:
a driving apparatus configured to control a longitudinal driving of the ego vehicle;
a braking apparatus configured to control a braking of the ego vehicle; and
a steering apparatus configured to control a lateral driving of the ego vehicle,
wherein, the controller is configured to control at least one of the driving apparatus, the braking apparatus and the steering apparatus so that the ego vehicle enters the target space.

13. The system of claim 11, wherein the first sensor comprises at least one of a front camera, a front radar, and a corner radar, and the second sensor comprises a GNSS (Global Navigation Satellite System) and a high-definition map.

14. The system of claim 11, wherein the controller is configured to rearrange the ego vehicle and the vehicles of interest in order from a vehicle with a shortest remaining distance to the merging point to a vehicle with a longest remaining distance, and select the target space based on a reward function in the rearranged state.

15. The system of claim 12, wherein, in the reward function, a reward value increases as a size of the target space becomes larger, as a speed loss required for the ego vehicle to enter the target space decreases, and as a travel distance required for the ego vehicle to enter the target space decreases.

16. The system of claim 12, wherein the controller is configured to select a vehicle of interest located in front of the target space as a target vehicle and perform control of the ego vehicle to follow the target vehicle.

17. The system of claim 16, wherein when the target vehicle is located behind the ego vehicle, the controller is configured to perform deceleration control of the ego vehicle by controlling the braking apparatus to move behind the target vehicle.

18. The system of claim 11, wherein if the target space cannot be selected, the controller is configured to stop or decelerate the ego vehicle before reaching the merging point and re-search for the target space.

19. The system of claim 13, wherein the controller is configured to extract road shape information of the driving lane and the merging lane based on the location of the ego vehicle and information from the high-definition map, and extract the merging point based on the road shape information.

20. A non-transitory computer-readable recording medium that records a program for executing a method for controlling a vehicle at a merging section on a computer, the method comprising:
extracting a merging point where a driving lane of an ego vehicle and a merging lane meet;
selecting vehicles of interest among surrounding vehicles located in the driving lane and the merging lane;
rearranging the ego vehicle and the vehicles of interest based on remaining distances to the merging point;
selecting a target space to enter among at least one space between the vehicles of interest and a rear space of a rearmost vehicle of interest; and
controlling the ego vehicle to enter the target space.
